(19) United States
(12) Patent Application Publication
(10) Pub. No.: US 2009/0234690 A1
(43) Pub. Date: Sep. 17, 2009

(54) Method and system for workflow management and regulatory compliance

(76) Inventor: Harold Nikipelo, Athabasca (CA)

Correspondence Address: OGILVY RENAULT LLP, 1, Place Ville Marie, SUITE 2500, MONTREAL, QC, H3B 1R1, CA

(21) Appl. No.: 12/320,887

(22) Filed: Feb. 6, 2009

Related U.S. Application Data
(60) Provisional application No. 61/006,925, filed on Feb. 6, 2008.
(60) Provisional application No. 61/091,636, filed on Aug. 25, 2008.

(51) Int. Cl. G06Q 10/00

(52) U.S. Cl. 705/7

(57) ABSTRACT

A system for workflow monitoring and regulatory compliance. The system is designed to receive information on safety hazards; carry out interactions among the plurality of program modules, the interactions including communication of information on the safety hazards; through the interactions among the plurality of program modules, identify safety procedures associated with the safety hazards; and through the interactions among the plurality of program modules, provide a series of instructions via an output to a user for ensuring regulatory compliance based on the identified safety procedures.

### RELATED APPLICATIONS

The present disclosure claims priority to U.S. Provisional Patent Applications Nos. 61/006,925 (filed Feb. 6, 2008) and 61/091,636 (filed Aug. 25, 2008), the entirety of which are hereby incorporated by reference.

### FIELD OF TECHNOLOGY

The present disclosure relates to a method and system for workflow management and regulatory compliance.

### BACKGROUND

In many companies and government agencies, there is a need to comply with regulatory requirements. Safety and risk management, as well as health and environmental monitoring, are particular areas requiring regulatory compliance. Some companies or agencies may find it difficult to ensure compliance, particularly where multiple levels of management and a large number of individuals and vendors make risk management and regulatory compliance very complex.

Existing safety compliance programs typically serve to record data relevant to safety, but it is still up to the user to recognize safety and compliance procedures that must be carried out, based on the recorded data. For example, when a power line is added to a work site, the user may enter information about the power line into an existing safety compliance program. However, it is up to the user to identify the power line as a potential hazard for future work on the site, and the user must remember that further work permits will require clearance for this hazard. This is burdensome on the user and results in a high risk of non-compliance. In some existing programs, this hazard may be recorded in a database. However, it is still up to the user to identify a newly installed power line, for example, as a hazard and to enter this as a new hazard into the database, and it is still up to the user to add appropriate safety procedures to a workflow to accommodate the new hazard. This is still a burden on the user, and relies on human memory and judgement to identify and track hazards.

It would be desirable to have a method and system for risk management or for ensuring regulatory compliance that would improve day to day regulatory compliance and workflow management, particularly in the areas of health, safety and the environment.

### BRIEF DESCRIPTION OF THE DRAWINGS

Aspects of the present disclosure will be discussed in detail below, with reference to the drawings in which:

FIG. 1 is a block diagram illustrating a system for ensuring workflow management and regulatory compliance;

FIG. 2 is a block diagram illustrating modules used in the system of FIG. 1;

FIG. 3 is a diagram illustrating functions provided by a module used in the system of FIG. 1;

FIG. 4 is a diagram illustrating functions provided by another module used in the system of FIG. 1;

FIG. 5 is a screenshot of a user interface in an embodiment of the system of FIG. 1;

FIG. 6 is a screenshot of a user interface useful for a provincial agency in an embodiment of the system of FIG. 1;

FIG. 7 is a screenshot of a user interface useful for sustainable resource management in an embodiment of the system of FIG. 1;

FIG. 8 is a screenshot of another user interface useful for sustainable resource management in an embodiment of the system of FIG. 1; and

FIG. 9 is a schematic diagram illustrating a computing device that may be used to implement the systems and methods disclosed.

### DETAILED DESCRIPTION

All examples and embodiments discussed in the present application are for purposes of illustration only and are not intended to be limiting.

A method and system for workflow monitoring and regulatory compliance is described. The method and system are directed to an integrated system that incorporates actions, such as day-to-day tasks, for monitoring and regulatory compliance. The method and system may also allow for effective asset management and generation of a workflow at a work site. The method and system may be used, for example, by a company or government agency in North America or the United Kingdom, and may be compliant with one or more of ISO, Canadian OHS, American OSHA, and British NEBOSH standards.

The method and system aim to provide due diligence through system tracking and to eliminate corporate liability by showing accountability and competency at both the personal and the corporate levels.

The method and system may ensure that an effective emergency response program is available and ready. The method and system may enable proper planning and implementation of universal safety standards such as ERCB, CSA Z731, ICS and National Incident Management System (NIMS) standards. The method and system may also ensure readiness of a company and its workers through preparedness training and simulations. The method and system may also ensure prompt and organized deployment of an emergency response program based on a set of universal guidelines, typically based on compliance with safety regulations, and may be capable of interacting with other agencies or firms. The method and system may also provide an overall review of an emergency event, personal and departmental assessments on how issues were handled, and provide for implementation of improvements that may be identified during the review.

In some aspects, there is provided a system for workflow monitoring and regulatory compliance comprising: a microprocessor; an input device for accepting an input to the microprocessor; a display device for communicating an output from the microprocessor; and a memory coupled to the microprocessor, the memory having a plurality of program modules configured to: receive information on safety hazards; carry out interactions among the plurality of program modules, the interactions including communication of information on the safety hazards; through the interactions among the plurality of program modules, identify safety procedures associated with the safety hazards; and through the interactions among the plurality of program modules, provide a series of instructions via an output to a user for ensuring regulatory compliance based on the identified safety procedures.

In some aspects, there is also provided a method for workflow management and regulatory compliance comprising: receiving information on safety hazards; carrying out interactions among a plurality of program modules on a system, the interactions including communication of information on the safety hazards; through the interactions among the plurality of program modules, identifying safety procedures associated with the safety hazards; and through the interactions among the plurality of program modules, providing a series of instructions via an output to a user for ensuring regulatory compliance based on the identified safety procedures.

In some aspects, there is also provided a computer program product having a computer readable medium tangibly embodying computer executable code for workflow management and regulatory compliance, the computer program product comprising: code for receiving information on safety hazards; code for carrying out interactions among a plurality of program modules on a system, the interactions including communication of information on the safety hazards; code for, through the interactions among the plurality of program modules, identifying safety procedures associated with the safety hazards; and code for, through the interactions among the plurality of program modules, providing a series of instructions via an output to a user for ensuring regulatory compliance based on the identified safety procedures.

By providing a plurality of interacting modules, the disclosed system may avoid reliance on a user to track hazards and safety compliance, thus reducing the risk of an incident occurring. The system may provide continued or periodic monitoring of workers and/or assets, in order to prevent an incident from occurring and improve individual accountability, for example by tracking error patterns. The system may also provide training to maintain worker competence and supervisor competence. The system may also ensure that a safety program implemented by a user is competent and/or compliant with regulations, such as health, safety or environmental regulations. The system may provide automatic generation of a workflow based on known risks and hazards for a worker's activity. The system may also provide an emergency response program.

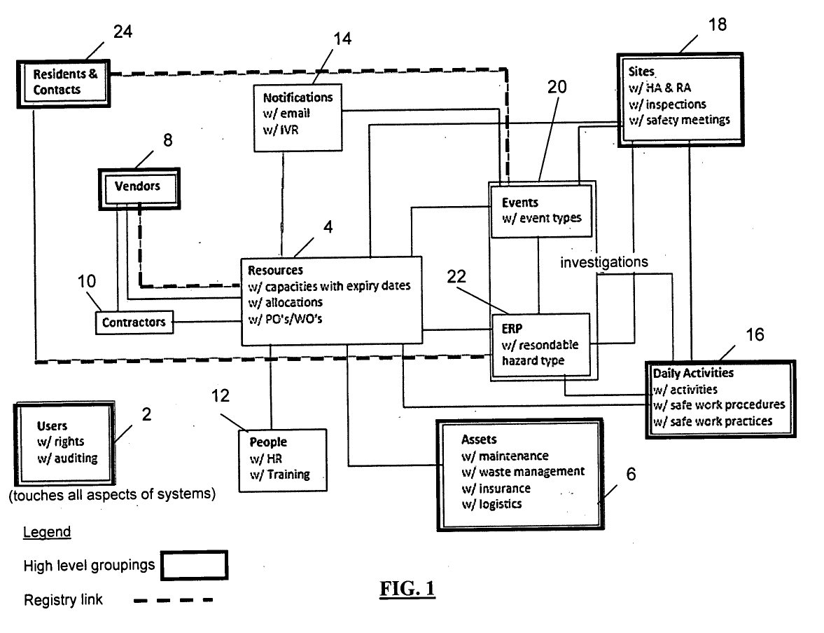

FIG. 1 illustrates a high level diagram indicating different aspects of workflow management and regulatory compliance that may be monitored or managed through the system. A user 2 may access the system, and use the system for managing rights and for auditing purposes. The system manages resources 4, including managing capacities and expiry dates, resource allocations, and purchase orders and work orders (POs and WOs). Management of resources 4 includes overseeing assets 6, for example the maintenance of assets, waste management, insurance for assets, and logistics in coordinating assets. Management of resources 4 may include interaction with vendors 6 and contractors 8. Management of resources 4 may also include managing people 12 or workers, and may include interactions with human resources and with training. Management of resources 4 may also include generation of notifications 14 (e.g., using email or interactive voice response (IVR)). Daily activities 16 of a worker are also managed, to ensure compliance with safe work procedures and safe work practices. Management of daily activities 16 is coordinated with management of work sites 18, including hazard assessment and risk assessment (HA and RA), inspections, and safety meetings. Data and assessments from the management of resources 4, daily activities 16 and sites 18, as well as the notifications 14 are used in managing events 20 and emergency response plans (ERPs) 22, based on the event type and/or hazard type. Management of events 20 and emergency response plans 22 is used to coordinate emergency response for residents and contacts 24.

Notifications from the system may be received and/or viewed using mobile communication devices, such as a BlackBerry™ or Palm™ device. Notifications from the system may be sent through a communication network, such as a wireless network or the Internet.

The system may consider certain aspects to be high level groupings. For example, users 2, assets 6, vendors 8, daily activities 16, sites 18, and residents and contacts 24 may be individually considered high level groupings. Events 20 and ERPs 22 may together be considered a high level grouping. There may also be registry links between different aspects. For example, there may be a registry link between residents and contact 24 and both events 20 and ERPs 22. There may also be a registry link between vendors 8 and resources 4. A registry link allows users access to a common registry, in which vendors, resources, assets and such that are known to comply with regulations are listed. The common registry allows sharing of information among users of the system, so that a vendor, for example, only has to register for regulatory compliance once and is identified as such to all users, rather than requiring repeated registration and/or validation of the same vendor for each user. There may be investigations between daily activities 16 and the events 20 and ERP 22 high level group.

The system may be used by all staff/employee of a company on a daily basis, and may not be limited to use by administrators. That is, this may be not just an administrative system that requires a team of administrators whose duty is to solely manage the system. Instead, every employee may use the system throughout the day.

The system may be used to track violations of policy (e.g., safety policy) and errors. The system may immediately notify and escalate these violations and errors where applicable. The system may provide users with a certain flexibility in their interactions. Conventionally, software is designed to minimize the need for data entry and the occurrence of user errors. To do this, the software may compare user input with, for example, acceptable input ranges, previous answers or historical data, with the intent of either correcting or preventing what the software considers erroneous user input. In the system of the present application, however, these user errors may not be prevented by the system. Instead, when such an error is detected by the system, the data containing the possible error may be flagged and a notification may be sent to the user's supervisor to inform the supervisor of the error. This aims to achieve true accountability on the part of the system users by allowing identification of competent and incompetent users in an automated fashion.

The system may communicate with other customers (e.g., individual companies using the system) or users running the system (e.g., running software for the system on other workstations or in other companies) to share specific, important data. While the system may ensure the data security of each customer, there may be cases where sharing certain data between customers and/or government agencies is beneficial. For example, in emergencies and disasters, the system may be able to share non-confidential data (e.g., the location and size of the emergency) between several other customers and/or government agencies in order to provide instant or timely and efficient coordination. This makes the system more beneficial to the customer, and may also provide an incentive for new customers to use the system if their neighbors, municipal agencies, or provincial agencies are already using the system.

The system may help or enable a user to pass a safety audit, which may be in compliance with regulations. The system may be designed to comply with health and safety regulations and legislation, as well as environmental regulations. User interaction, data recording and reporting may be tailored to allow a user to pass a safety audit. In cases where special circumstances are required that are beyond standard regulations, the system may be extendible or modifiable to allow custom user interaction, data recording and reporting, in order to accommodate the special circumstances.

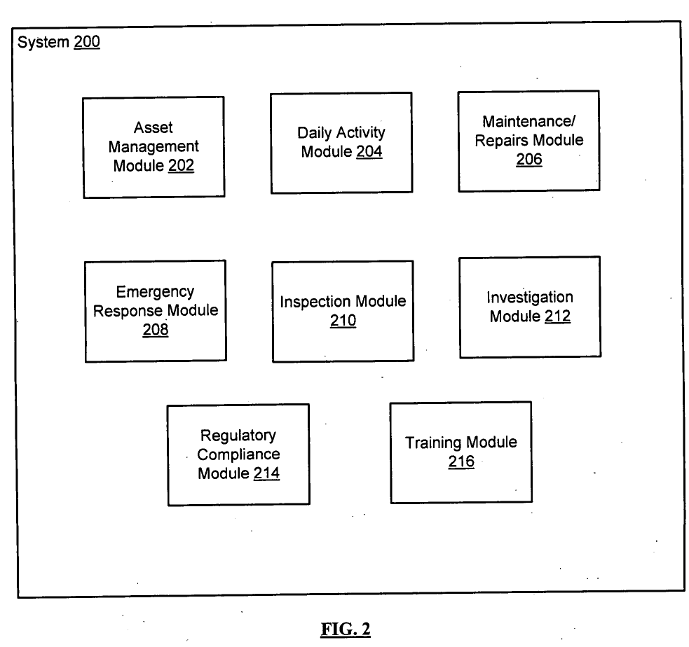

FIG. 2 illustrates the system 200 for workflow management and regulatory compliance. The system 200 may include eight interlinking modules. The system 200 uses the modules together to evaluate the organization, division, or individual based on the level of competency or skill level, by gathering selected data from each module. These separate modules or functionalities may be tightly integrated within the system 200. Comprehensive integration of all the functionality and data in the system 200 may be an advantage of the system 200. The different modules in the system 200 may be designed to work together seamlessly across different users, different duties, and different worksites or workstations. Data may be tied together in a logical way under the modules so that each module has access to all of the data the module requires without requiring the user to manually duplicate the data between modules. Not only may each module generate events and notifications in other modules, but each may also have timely access to pertinent information from every other module automatically. These modules each may interact with the aspects of workflow management and regulatory compliance described with respect to FIG. 1. Access to the modules may be restricted based on the organizational level of the user (e.g., a worker at a site might have more restricted access than an Incident Commander at the municipal level).

The system 200 may comprise the following modules: Asset Management Module 202, Daily Activity Module 204, Maintenance/Repairs Module 206, Emergency Response Module 208, Inspection Module 210, Investigation Module 212, Regulatory Compliance Module 214, and Training Module 216. Each of these modules will be described in greater detail below.

The system 200 and its modules may be implemented in a work station having a computing device. A user may use the work station to access and interact with the system 200, including generating reports, obtaining safety and competency assessments, and inputting updates on workers' activities.

In an example, the system 200 is intended to be used by everyone, everyday, and is not limited to use by organizational administration. The system may immediately notify and escalate violations of policy. The separate modules 202, 204, 206, 208, 210, 212, 214, and 216 are integrated with each other within the system 200. A computing device using part or all of the system 200 may communicate with other customers running the software to share specific, important data. The system 200, when properly implemented and used, may help ensure compliance with health, safety and environmental regulations.

Although specific modules are described, a person skilled in the art would understand that the system 200 may omit one or more of the described modules, or include other modules not described here, depending on the needs of the user. In an embodiment, the system 200 includes the modules 202, 204, 206, 208, 210, 212, 214 and 216 to ensure adequate workflow management and regulatory compliance. The system 200 and its modules may be customized to the needs of each user.

### Asset Management Module

The Asset Management Module 202 interacts with the other modules based on the daily activity of the worker, the location of the worker and the actual job site where the work is taking place, as well as which physical asset or resource is being used. Examples of a physical asset or resource that may be tracked include equipment such as trucks, consumables such as chemicals, and employees.

Each location is associated with a detailed inventory of all assets, both physical assets and resources, that are available. All assets are tracked both for receiving and for shipping, including both physical assets and resources, to ensure all costs are recorded. These records may be time records, which may track the time or date of receiving and/or shipping, and any expiration dates. The Asset Management Module 202 also ensures that regulatory requirements necessary to maintain the asset are met and are in agreement with the Maintenance/Repairs Module 206. Special asset management programs may be implemented to ensure proper maintenance specifications. Procedures to ensure that regulatory requirements are being met may also be managed using the Asset Management Module 202. Management programs include process management systems and management of change. The Asset Management Module 202 also maintains resource tracking, and may coordinate with human resources departments to ensure that special dates and periods in time (e.g., scheduled maintenance shut downs) are identified, and that achievements (e.g., successful completion of a project) are reportable and acknowledgeable.

### Daily Activity Module

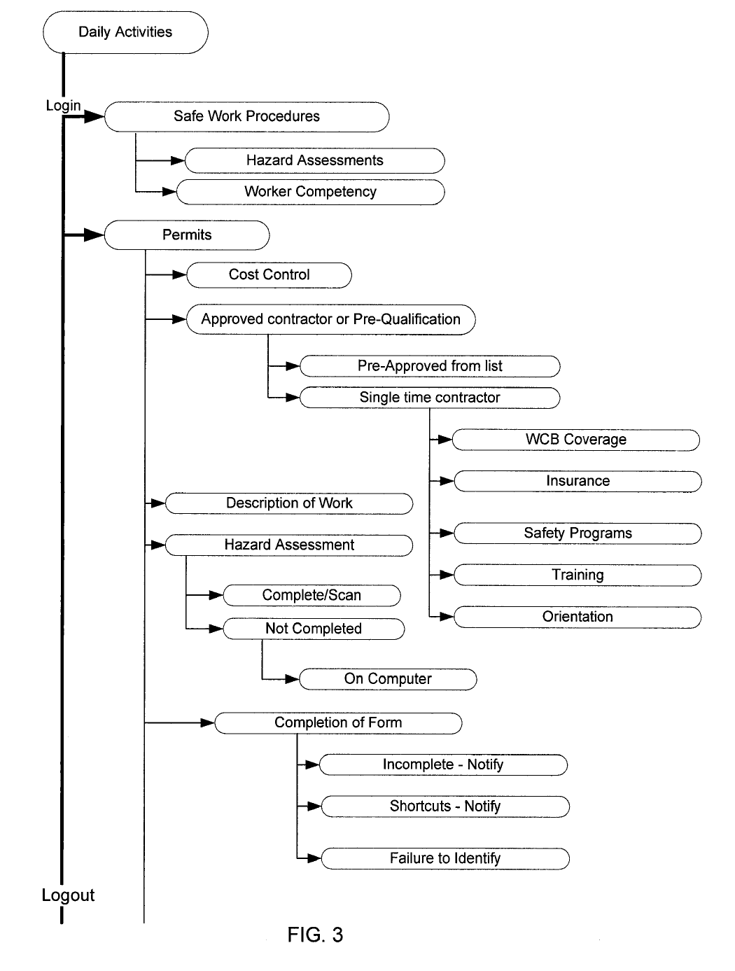

Reference is now made to FIG. 3, which illustrates a hierarchy of functions performed by the Daily Activity Module 204. The functions shown in FIG. 3 are described in greater detail below.

In general, the Daily Activity Module 204 serves to track a worker's regulatory compliance. When a worker uses the system 200, for example when logging on, the daily activity of the worker is communicated to the Daily Activity Module 204. The Daily Activity Module 204 assesses the worker's daily activity to ensure that the correct hazard assessments are being conducted, and provides reviews of the relevant safe work procedure, which may be based on frequency, severity and type of work. Daily activities may be carried out by the worker or may involve a third party.

One possible activity carried out by a worker may be the issuing of work permits for third party or contractor work. The Daily Activity Module 204 monitors various elements during this activity as described below.

The Daily Activity Module 204 may monitor costing based on the location of the activity. The Daily Activity Module 204 may monitor the third party or contractor to ensure that the contractor is pre-qualified. If a new contractor is selected, the Daily Activity Module 204 checks that the contractor meets certain requirements to perform work on the site and notifies the safety department of a new contractor. These requirements may be identified based on existing regulations, or the requirements of a contracting party. Typically, all contractors are screened to ensure that they meet certain requirements set by the contracting company or agency. A given contractor may be pre-qualified (e.g., already known to have regulatory compliance and registered in the common registry) or a one-time contractor. The Daily Activity Module 204 may allow for a one-time user however a notification will be set to have the firm pre-qualified or simply a one-time user. The Daily Activity Module 204 may require all one-time contractors to present certain information, for example Worker's Compensation Board (WCB) information, insurance coverage, safety information and proof of training.

The Daily Activity Module 204 may monitor how the issuer issuing the activity completes a set standard form (e.g., a work order) to ensure that the contractor is completing this form correctly. This may be by identifying key words in the entry describing the work taking place. If an incorrect entry is made or something is omitted, a notification may be sent to the issuer to notify a higher level, for example a supervisor. At the same time a notification may be sent to both the supervisor and the safety department of the issuer to correct the issue. This activity may be recorded and assessed by the system 200 based on the competency of the issuer or error in the activity. This may form part of a worker competency scoring which may be accessed by other modules within the system 200. For example, the Training Module 216 may have access to this scoring to evaluate the effectiveness of recent training.

Using the Daily Activity Module 204, an individual worker may indicate what activity is to be done. The system 200 may assess each activity to ensure that hazard assessments are being conducted, and may also review the safe work procedure based on the frequency, severity and type of work being performed. For example, the review may be based on the likelihood of the activity and a risk assessment of the activity. This review may be carried out based on existing regulations, or requirements of a contracting party.

The Daily Activity Module 204 may also ensure that a hazard assessment has been conducted on the work site and that a copy of the assessment is on file. If a hazard assessment has not been completed, then the Daily Activity Module 204 may prompt the issuer to complete a hazard assessment and provide a copy of the assessment to the contractor. If the issuer attempts to not complete the hazard assessment or mark it not applicable, then the Daily Activity Module 204 may generate a notification to the issuer's supervisor. A notification may also be sent to both the supervisor and the safety department. This may be a recordable competency measuring tool. If hazards have been identified, descriptive corrections or preventive measures may be provided to the contractor. Such hazards, corrections and preventive measures may be addressed at a pre-job safety meeting with the contractor prior to starting work. If hazards are not identified in a current activity, but were identified for the same activity in the past, the Daily Activity Module 204 may flag the hazard assessment, confirm with the issuer and then provide notification that either the hazard was overlooked or that changes have occurred to address the hazard that have not been entered into the system 200. This may indicate that the system 200 or Daily Activity Module 204 is not being used at all times.

The Daily Activity Module 204 may ensure that special requirements are identified and that these requirements are carried out in order to complete the task that the permit is being issued for. For example, gas detection may be required when entering confined spaces, and the Daily Activity Module 204 may provide a worker with a pop-up dialog reminding the worker to carry out gas detection.

The Daily Activity Module 204 may monitor contract workers to ensure that all workers have received a site specific orientation. For example, completion of an orientation for each worker may be entered into a database in the system 200, and the Daily Activity Module 204 may identify any worker that lacks the proper orientation based on the information in the database.

The Daily Activity Module 204 may track all work permits for a work site. This allows the Daily Activity Module 204 to monitor if conflicting work permits have been issued. If so, the Daily Activity Module 204 may identify this and notify the issuer. The Daily Activity Module 204 may monitor the closing out of all work permits and ensure that the work site is ready to receive other contractors or workers.

The Daily Activity Module 204 interacts with the other modules to ensure worker safety, for example by creating pop-ups to send reminders of special activities, safe work practices based on the activity and frequency of that activity, required training refresher items such as emergency response skills, and reviews of material safety data sheets (MSDS) (e.g., when handling or working with chemicals). The Daily Activity Module 204 may track the response of individual worker responses to these pop-ups, and the response may be used to assess worker competency. If a worker fails to read or respond to such pop-ups, the Daily Activity Module 204 may provide a notification to a supervisor, based on frequency and severity of the failure, for example as required by safety regulations. This may allow for monitoring of worker behavior. This monitoring may take place when the worker is active on the system 200 and may not be active when the system 200 is not in use. This may prevent premature notifications where the worker is not using the system 200, and may also prevent the worker from being disturbed during another activity, for example a meeting.

The Daily Activity Module 204, when used at the municipal level, may allow municipalities to track permit issuing (e.g., for overweight transportation, transportation of dangerous goods) and this information may be provided to the other modules. This may allow a user to track revenue from such activities.

The system 200 may include a telephone interface, for example, the Daily Activity Module 204 may be telephone activated.

### Maintenance/Repairs Module

The Maintenance/Repairs Module 206 allows tracking of the usage and maintenance of items, in accordance with regulations. Additional tracking and/or maintenance may also be customized based on the requirements of each user.

The Maintenance/Repairs Module 206 interacts with other modules and activities, and these interactions may be based on whether the activities are internal (e.g., with the production of a work order) or external (e.g., with the production of a purchase order on the permitting system).

Once an item has been identified as requiring repair either by keeping track of the run time, the manufacturer's requirements or regulatory requirements, the item is entered into the system 200, and is then tracked in the Maintenance/Repairs Module 206, the Asset Management Module 202, and the Regulatory Compliance Module 214. During the reporting stage, the item being repaired is tracked in at least one of the Maintenance/Repairs Module 206, the Asset Management Module 202 and the Regulatory Compliance Module 214 based on the reports required. Identification of an item requiring repair may be performed by a worker, or may be performed by the system 200 based on the receiving date of the item.

Any products used during the maintenance are also tracked based on availability (including quantity), location and disposal location. In the Maintenance/Repairs Module 206, proper tracking paperwork is generated and tracked to show the events, including the product locations and final receiver, including verification of quantity. For example, in compliance with the Used Oil and Dangerous Goods Act, a waste manifest report may be generated for the appropriate products.

The Maintenance/Repairs Module 206 may also perform process management, tracking of disposal of all materials including hazardous waste, and develop and maintain maintenance programs.

### Emergency Response Module

The Emergency Response Module 208 may be designed to ensure conformance to certain regulatory requirements, for example the CSA Z731 and NIMS standards in the case of North American regulatory compliance. The Emergency Response Module 208 may have five different levels of hierarchy, each with different functions, which are described in detail below. The five levels may include: level one for supply and service firms; level two for oil and gas companies; level three for municipal level services; level four for provincial/state level services; and level five for federal level services. The Emergency Response Module 208 may be designed to be used for emergencies including medical, fire, natural disaster and environmental emergencies.

The Emergency Response Module 208 may activate an Incident Command System (ICS) in the event of an emergency, to carry out an emergency response plan. The emergency response plan may have five different levels (for example, supply and service firms, oil and gas industry, municipal level services, province/state level services, and federal or homeland security level services) each with different levels of detail and functions, which will be described below. The functions of the ICS may be automatic or manually operated. If manually operated, the Emergency Response Module 208 may provide the user with recommended actions. The Emergency Response Module 208 may track all activities carried out during the emergency, as well as environmental monitoring and tracking of resources and availability.

At level one, the Emergency Response Module 208 may not provide a detailed ICS emergency response program. At this level, the Emergency Response Module 208 may provide a generic site-specific emergency response plan based on a given location and any emergency phone numbers that have been entered into the system 200 by the user. The Emergency Response Module 208 may identify potential emergencies, set procedures on how to deal with those emergencies, identify the location of emergency equipment, identify the closest medical facility, identify fire fighting equipment, identify the location of the closest medical services if required, and identify the need for rescue or evacuation personnel/equipment and any designated rescue and evacuation personnel. The Emergency Response Module 208 may also provide general directions to the work location and directions to the closest medical facility. A detailed ICS emergency response program may not be provided at this level.

At level two the Emergency Response Module 208 may provide detailed emergency response plans based on a given inputted location, and may provide a detailed ICS program on how the emergency response plan will be developed. The emergency response plan may be inputted by a user, or may be pre-set in the system 200 in accordance with safety regulations. Planning may include logistical information on residents, services and supplies needed in case of an emergency such as a fire, a medical injury or death, a natural disaster, a spill or a natural gas release into the atmosphere or other such emergencies. Such information may be limited to residents, services and supplies within a geographical area. Information on residents may include information such as the name of the main resident, names of additional residents (e.g., children) and ages, school grades of any children, any parental restrictions, mode of transportation to and from school, any special needs required, known medical conditions, pets (which may include information on whether a pet is kept indoors or outdoors), types and numbers of farm animals, types of structures and building materials, roof construction material (e.g., wood, metal, tar), any basement structure, type of vegetation around the building, closest water supply (e.g., dugout, lake, pond, river swimming pool), storage of any dangerous goods products (e.g., tanks of fuel, propane), topographic elevations around homestead (e.g., on a hill or a slope, in a valley, level), and whether there is easy access for large equipment. Information on services may include information on the types of services, numbers of vendors capable of supplying services, whether the resident has a certificate of recognition or a safety program, whether the equipment meets the requirements for road worthiness (e.g., based on requirements from a Department of Transportation), whether the equipment has been inspected within the past year. Information on supplies may include information on the name of the supplier, the product supplied (e.g., food, safety supplies, lodging, clothing, general construction material, building material, temporary lodging facilities, or sanitary waste products such as portable lavatories), and amounts of products available.

The emergency response program may include a planning stage, a preparedness stage and finally a deployment stage when an emergency actually occurs.

In the planning stage, information may be gathered based on the geographical location and requirement of the emergency response plan. This information may be gathered by the user. Based on a number of criteria, such as the type of operation, production parameters and other factors which play a key role in emergency response, an affected area is determined for a given emergency. Production parameters may include KPa, percent, toxicity levels, known weather patterns, or terrain.

At level two, the Emergency Response Module 208 also includes a preparedness stage. During the preparedness stage the Emergency Response Module 208 is maintained at a ready state with an appointed ICS personnel assigned on a rotation. During this stage, simulations may be performed to ensure a state of readiness and that all information stored in the ICS data center is correct and up-to-date. The simulations may be performed in response to user prompting or may occur randomly, as pre-selected by the user. During the preparedness stage, primary and secondary communications systems may be monitored to ensure that they are active and functional, including backup systems, to ensure communication. The Emergency Response Module 208 may perform the simulation and record the results on a routine basis and send out positive or negative notifications for all tests. The Emergency Response Module 208 may also carry out regular testing of the ICS call-out center to check its functional capability. This may also be recorded on a routine basis and positive or negative notifications may be sent out on all tests.

At level two, the Emergency Response Module 208 also includes a deployment stage. During the deployment stage, each position (e.g., a position in an emergency response team) will have set responsibilities that they must ensure are carried out. The Emergency Response Module 208 may display these responsibilities, for example on the right hand side of a monitor at a work station. Once each responsibility has been addressed, confirmation will be asked of each position to re-confirm that the responsibility has been carried out, and whether any other resources are required to meet any changes based on the set objectives of the Incident Commander. The Incident Commander may have access to see all four chief screens on a workstation if required. The Incident Commander may also ask the next level higher to either suggest or takeover command by simply selecting this as part of the Emergency Response Module 208 function. The Emergency Response Module 208 may also perform a post-incident review of all logs and assessments based on the competency level of each function (e.g., in compliance with NIMS).

At level three, the Emergency Response Module 208 has functions working at the municipality level. At level three, the Emergency Response Module 208 may have full access to the system and information of the lower levels. The Emergency Response Module 208 at level three may perform the same functions as described above for level two, and may also provide interaction between corporate firms and municipal agencies. The Incident Commander may ask the next level higher to either suggest or takeover command by simply selecting this as part of the Emergency Response Module 208 function. When this function is used, the next higher level of command may have access to the chief's data and all field communications if required. For example, command may transfer from an oil and gas firm to municipal operations. Neighboring municipalities' maps may be shown on a mapping system provided by the Emergency Response Module 208. Once an event is noted the latitude and longitude may be entered (e.g., using LSD conversion) and the location may be displayed on the map, including distances from the event to the closest resources such as hospitals, shelters, or water sources. Where neighboring municipalities all use the system 200, information on the available resources in a neighboring municipality may be displayed, for example if a mutual aid agreement is in place among the municipalities. The user may prompt the Emergency Response Module 208 to determine a certain radius around the location and a notification may be sent out to all residents within the radius. Alternatively, transmission of this notification may be required by regulations and may occur automatically. This radius may be selected by the user or may be pre-determined and preset. This notification may be manually sent or automatically sent by the system 200. The next level of Incident Command may have direct access to all logs and reports, and may interact with the existing Incident Command if asked or if the higher level of service is just monitoring. This access may include access to all radio communications. Once the deployment is complete, the system 200 may provide a report including a competency report. The competency report may include assessment of competency on following set objectives, timely operations, data reporting, pre-gathering of information, communication flow and organization flow. At level three, the Emergency Response Module 208 may also perform post-incident review of all logs and assessments based on the competency level of each function (e.g., in compliance with NIMS).

At level four, the Emergency Response Module 208 has functions working at the provincial or state government level. The Emergency Response Module 208 at level four may perform the same functions as described above for level two and level three, and may provide further interaction between the municipal agencies and the provincial or federal jurisdictions. Using the system 200, the provincial or federal organization may monitor all municipalities, for example by simply selecting a municipality on a map using a point-and-click interface. If the municipality is in a normal status, the corresponding map area may be white; as soon as an alert is indicated the ICS is activated, then the map area of the corresponding municipality may be shown in yellow and the system 200 may send out an alert or notice (e.g., via e-mail). Once the municipal service acknowledges a disaster setting, then the map area may be shown in red. The Incident Commander may ask the next level higher to either suggest or take over command by simply selecting this as part of the Emergency Response Module 208 function. When this function is used, the next higher level of command may be provided with access to all of the chief's data and may listen in on all field communications if required. For example, transfer of command may be from an oil and gas firm to municipal operations, or from municipal to provincial operations. The next level of Incident Command may be provided with direct access to all logs and reports, and may interact with the existing Incident Command if asked or the higher level Incident Command may be asked to just monitor. This may include access to all radio communications. Once the deployment of the emergency response is complete, the system 200 may generate a report, including a competency report. The competency report may include an assessment of competency on the following: set objectives, timely operations, data reporting, pre-gathering of information, communication flow and organization flow. The Emergency Response Module 208 may also perform a post-incident review of all logs and assessments based on the competency level of each function (e.g., in compliance with NIMS).

At level five, the Emergency Response Module 208 operates at the federal government level. At this level, there is full access to the system and information of all lower levels. At level five, the Emergency Response Module 208 allows monitoring of all provincial or state activities simply by having a user select the desired map on the display screen. Normal status may be displayed as a white map, which may turn yellow when an alert is indicated or when the emergency system for that map is activated. The alert or notice may be sent out via standard communication channels, such as by email. Once the disaster setting is acknowledged at the municipal or provincial/state level, the related map may turn red.

The Emergency Response Module 208 may provide a weather data interface, e.g. for store tracking, travel projections and notifications. The weather data interface may allow for automatic weather warnings and alerts, but may not provide evacuation notices. Notification settings for the Emergency Response Module 208 may allow for selection of the area requiring notification, and may be different from the common reverse 911 systems. The Emergency Response Module 208 may identify an area based on information available. For example, where a plume has been identified, alerting the system 200 of an incident, the appropriate area may be notified. The Emergency Response Module 108 may using a geographic information system (GIS) mapping to automatically pre-select emergency services (e.g., suppliers, fire departments, ambulances, emergency medical teams, hospitals and other medical services) closest to the incident area. Suppliers and service provides may log into the system 200 and provide updates on available supplies and/or services, and they may be tracked and/or color-coded based on the most recent update. The system 200 may allow for automatic pre-qualification of suppliers and services based on regulations (e.g., if the supplier is already validated in the common registry). The Emergency Response Module 208 may allow the staff of the Incident Command to log in to assist or support the present Incident Command, and command may be transferred between the different levels. Interface with the system 200 may be via a web-based interface, a radio interface, or a telephone interface. All interactions with the Emergency Response Module 208 may be logged and recorded for post review. The level at which the Emergency Response Module 208 is active may depend on the user. As described above, each level may correspond to a different administrative level, and some levels may be active while others are not.

### Inspection Module

The Inspection Module 210 interacts with the other modules to ensure that inspections are occurring on a regular basis based on the workers' activities (e.g., in compliance with regulations such as OHS and OSHA). These inspections may be formal or informal. The purpose of a workplace inspection is to identify hazards that could be dangerous to the worker, other workers, or property; to identify the corrective action; and to ensure that the corrective action eliminates the hazard. Workers are commonly exposed to hazards at work, leading to a risk of injury or property damage. These risks may be reduced or eliminated simply through identification of the hazard, which would prompt corrective action. The Inspection Module 210 may coordinate informal or formal inspections as described below.

An informal inspection is an inspection which the worker may not clearly understand to be an inspection. Informal inspections typically are not time sensitive. For example, a worker may be asked whether he or she has reviewed the work area for trips, slips and fall hazards. If the answer is yes then the worker has provided a response; if the answer is no, then the worker may be prompted to conduct the inspection and provide a response. Others possible informal inspections include assessing the height of a desk, a table or other work area; or assessing the height of a chair to determine whether it meets the recommended standard as to ergonomics. The Inspection Module 210 may coordinate daily informal inspections, such as prompting workers in non-work-sensitive areas on a routine basis. The prompting may comprise posing questions to a worker. The questions may be varied to meet the common goal of carrying out these inspections without disturbing the worker. Urgent workers in site-sensitive areas may be prompted to conduct inspections on a regular basis and to ensure that follow-up items are addressed.

Formal inspections are focused around timed events, and may be conducted at regular intervals. Inspections, whether formal or informal, may occur on a regular basis.

The Inspection Module 210 may interact with other modules to ensure that each module is tied into each other, for example to coordinate which hazard assessments and control measures are put into place. This may be done to ensure that these control methods are used and are functional. The Inspection Module 210 may be in a working loop with other modules of the system 200 to ensure that each module interacts with each other, to ensure that hazard assessments and control measures are put in place. For example, interaction with the Daily Activity Module 204 may include communication procedures, emergency planning, general procedures and inventory of personal protective and safety equipment, based on a worker's daily activity.

### Investigation Module

The Investigation Module 212 may be used to identify and track trends on near-misses and incident occurrences. Once a trend is identified, corrective activities may be created and/or prompted by the system 200 to prevent the event from occurring by education, awareness and supervision of the relevant workers.

The Investigation Module 212 may provide a standard form to be used for the reporting of all near-misses or incidents. The Investigation Module 212 may also provide guidance in completing the form, for example by providing pop-ups to educate the worker on why this is important. Once the form is activated it may be tracked on both timelines and in the review process, thus ensuring that all parties are aware of the near-miss or incident as well as who should be notified. The Investigation Module 212 may provide immediate notification to supervisors, the safety department and managers to ensure that all parties are aware of all incidents higher than a level two incident (e.g., any incident resulting in property damage or injury). The Investigation Module 212 may also provide the parties with guidelines on when and what should be reported. The Investigation Module 212 may assist the author of the near-miss or incident report to ensure that all the required questions have been answered in order to complete the report correctly and completely. The Investigation Module 212 may provide supervisors and management with a detailed report of the near-miss or incident. The Investigation Module 212 may also provide supervisors and management with a current trend analysis and suggestions on how to eliminate or reduce the trend. The Investigation Module 212 may ensure that all incidents and near misses that have been reported within a company or organization are placed on the safety meeting agendas.

### Regulatory Compliance Module

The system 200 may have access and/or links to regulations, such as health, safety and environmental regulations. The system 200 may also have access and/or links to upcoming regulation changes and/or recent updates to regulations. This information on regulations may be stored in or communicated to the Regulatory Compliance Module 214.

The Regulatory Compliance Module 214 is a functional resource module that identifies municipal, provincial, state and federal legislation on all activities that have been identified using the Daily Activity Module 204. The Regulatory Compliance Module 214 aims to identify the tasks that the worker undertakes, identify the regulatory requirements required to ensure regulatory compliance and to validate that those requirements have been met (e.g., by using other modules or by performing the appropriate activities). The Regulatory Compliance Module 214 may provide reporting and statistical data at a management level to indicate the level of regulatory compliance and to suggest ways to improve operations within regulatory objectives.

### Training Module

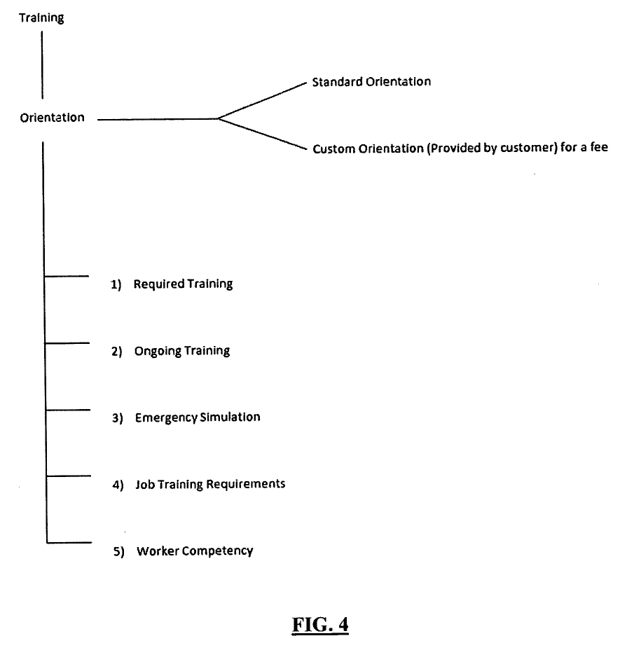

Reference is now made to FIG. 4, illustrating a hierarchy of functions provided by the Training Module 216.

The Training Module 216 may include a standard orientation. The standard orientation may be for all employees in a company or may be unique to a certain company or certain workers in the company (e.g., with an additional cost of $1000.00 for all employees). This may include annual re-orientations and reminders to a worker who is staying another year with the company.

The Training Module 216 may provide tracking of all training requirements for a given position or may be as set by the company. The Training Module 216 may send out reminders about the need for training updates (e.g., an alert at 3 months and 2 months, and weekly alerts). The Training Module 216 may also provide on-going training, for example through pop-ups on safe work practices when using hand tools or other specialized equipment, code requirements such as fire extinguisher training, refresher mandatory training requirements such as first aid, H₂S awareness and emergency response planning and preparedness. This training may be based on previous scoring or competence level. The Training Module 216 may provide simulated emergency response drills either on a single worker basis or on an office-wide basis, and may be at regular intervals, for example at a minimum of every 6 months (e.g., one fire and one medical emergency), based on regulations. The Training Module 216 may also keep track of all on-the-job training requirements and check-offs by supervisors to ensure worker competency. On-the-job training requirements may be required to be done on a routine basis yearly or every 6 months for more critical training. The Training Module 216 may interact with other modules to assess the worker's competence and may be used to determine how often safe work procedures appear. The Training Module 216 may also perform worker scoring (e.g., competency scoring). The Training Module 216 may also provide reports to the worker's supervisors in response to a request from the supervisor. The Training Module 216 may include task inventory individual list development. Factors considered by the Training Module 216 may include training intervals, experience level of the worker, the results of previous training, and time of the previous supervisor check-off. Training may include pop-ups which may show a tip or a hint, such as “Did you know . . . ” or “would you like more information?”. The response to these pop-ups may be timed. For supervisor evaluation, the scoring summary for an individual worker may not be made available to the supervisor until after the supervisor scores the individual. Thus the Training Module 216 may compare scores and supervision competency. For new employees, this training and scoring may be conducted within 3 months of joining the company, or as required by regulations.

In addition to the modules and functions discussed above, the system 200 deals with permissions of dangerous goods being brought into the work place, provides for the locations of utility lines using GPS coordinates and is designed to work with handheld portable devices.

The system 200 may be provided on a network. For example, individual user terminals, servers of a company and/or government organization, telephone call routing servers and database servers may all communicate with each other through a public network such as the Internet, via secure channels, as is commonly known in the art. The system 200 and its modules may be located in a central server in the network that is accessible by all parties. Alternatively, individual modules may be located in different parts of the network. For example, the Emergency Response Module 208 may be located in a central server so as to be accessible by all parties, while the Daily Activity Module 204 may be locally located in a server of a company or in individual user terminals so as to be accessed only by individuals of the company or the relevant worker. There may be secure communication links between certain modules, to ensure that sensitive information is properly protected from outside access. There may be duplicates of the modules throughout the network. For example, where the Daily Activity Module 204 is local to a company server, each company using the system 200 may have its own copy of the Daily Activity Module 204 located on its own server.

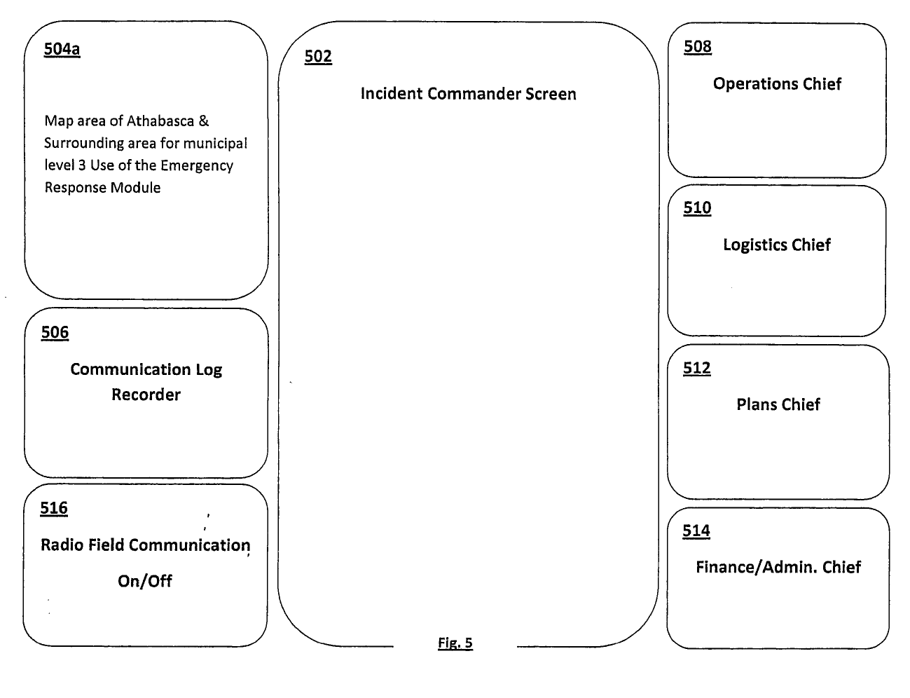

Reference is now made to FIG. 5, which illustrates a screenshot of a possible user interface for the system 200. In this example, the user may be an Incident Commander accessing the Emergency Response Module 208, and may be presented with a central Incident Commander screen 502. The interface may include a map 504a of the area being monitored, and a communication log recorder 506 for logging communications, for example between different sites or levels or command. The interface may also include screens showing activity by other users, such as an Operations Chief screen 508, a Logistics Chief screen 510, a Plans chief 512, and a Finance/Administration Chief screen 514. The screens 508, 510, 512, and 514 for the chiefs may display activity, functions or data under the supervision or command of the respective chiefs. The interface may also include a radio field communication button 516, which allows the user to turn radio field communication on or off.

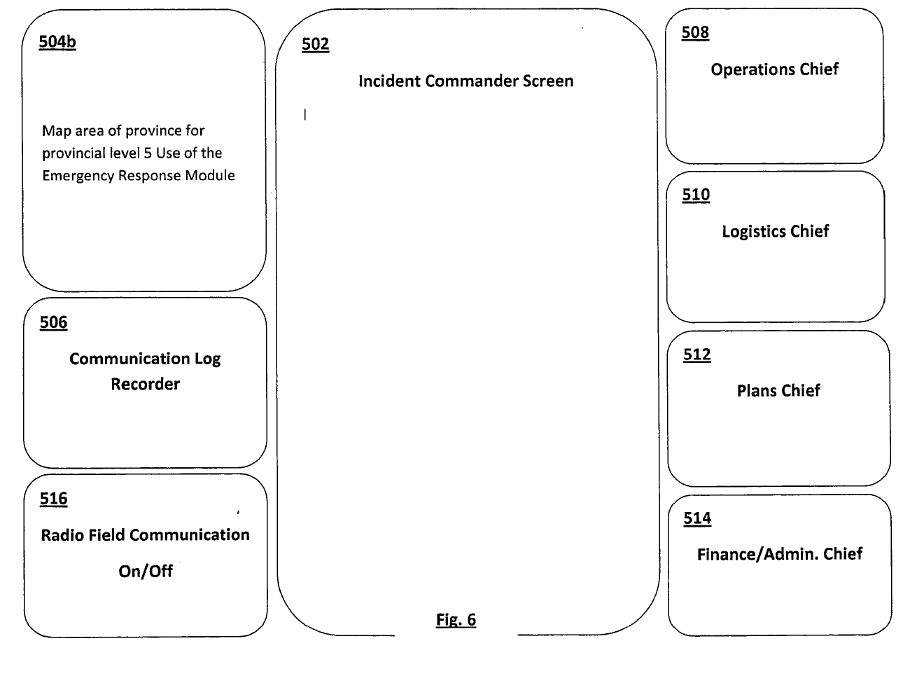

Reference is now made to FIG. 6, which illustrates a screenshot of a possible user interface for the system 200, useable for a provincial agency accessing the Emergency Response Module 208 at the provincial level, such as the Alberta Emergency Management Agency. In this example, the user may be an Incident Commander. The user may be presented with screens similar to those described above for FIG. 5, including the Incident Commander screen 502, the communication log recorder 506, the Operations Chief screen 508, the Logistics Chief screen 510, the Plans chief 512, and the Finance/Administration Chief screen 514. The interface may also include the radio field communication button 516. The map 504b may show a larger geographical area, for example the entire province of Alberta.

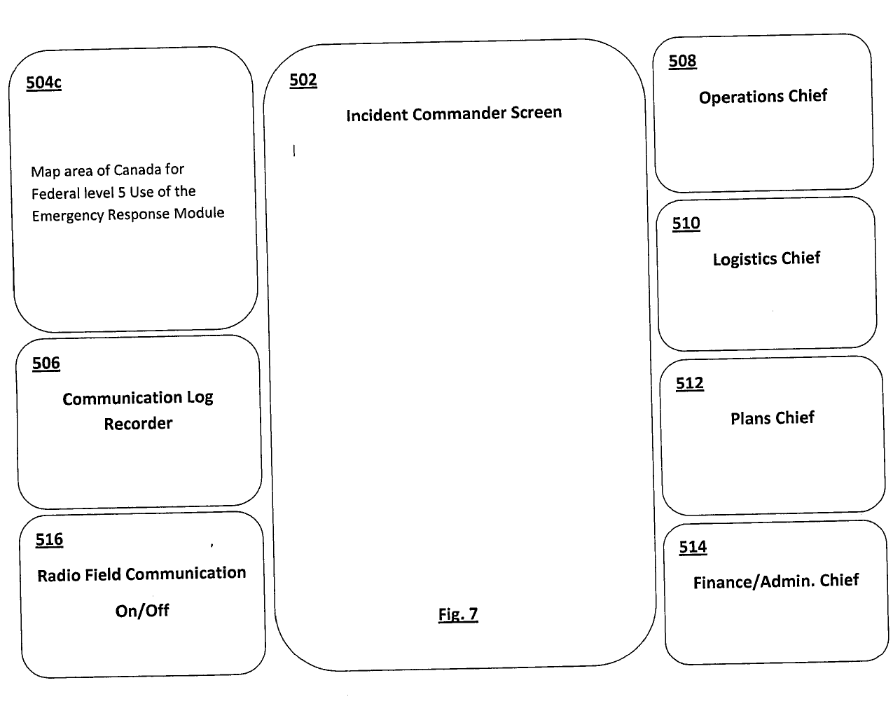

Reference is now made to FIG. 7, which illustrates a screenshot of a possible user interface for the system 200, useable for sustainable resource management. In this example, the user may be an Incident Commander. The user may be presented with screens similar to those described above for FIG. 5, including the Incident Commander screen 502, the communication log recorder 506, the Operations Chief screen 508, the Logistics Chief screen 510, the Plans chief 512, and the Finance/Administration Chief screen 514. The interface may also include the radio field communication button 516. The map 504c may include information about sustainable resources, and may include zoning information such as fire control zones.

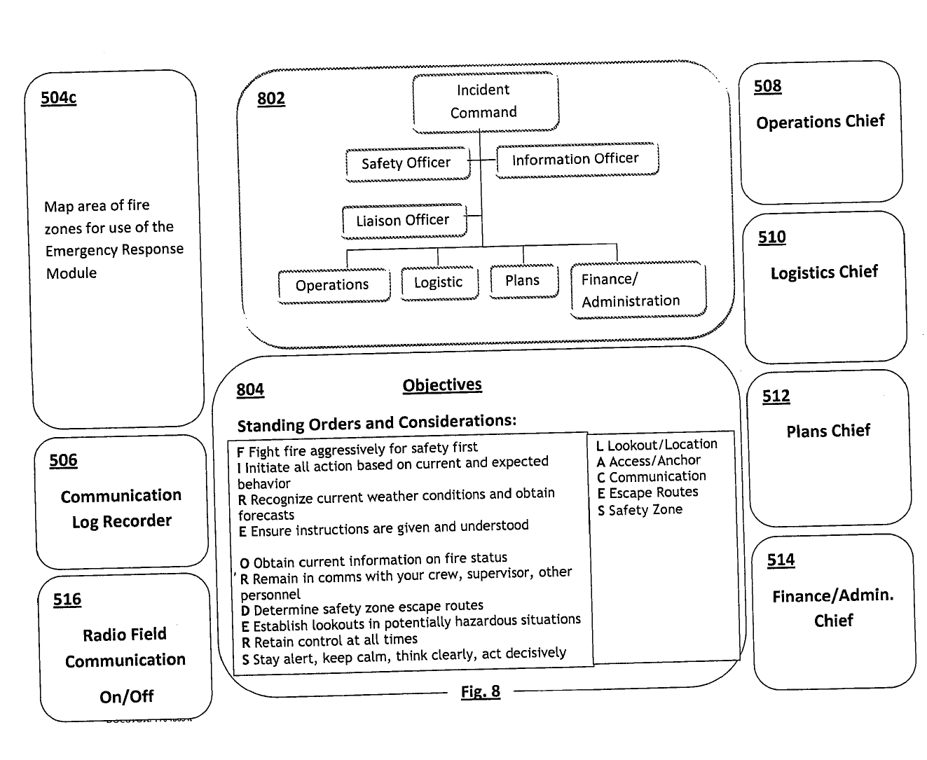

Reference is now made to FIG. 8, which illustrates a screenshot of another possible user interface for the system 200, useable for sustainable resource management. In this example, the user may be an Incident Commander. The user may be presented with screens similar to those described above for FIG. 5, including the communication log recorder 506, the Operations Chief screen 508, the Logistics Chief screen 510, the Plans chief 512, and the Finance/Administration Chief screen 514. The interface may also include the radio field communication button 516. The map 504c may include information about sustainable resources, and may include zoning information such as fire control zones. The user may be presented with a hierarchy 802 showing the command structure, including the Incident Command, the Safety Office, the Information Office, the Liaison Officer, the Operations Chief, the Logistics Chief, the Plans Chief, and the Finance/Administration Chief. The user may also be presented with an objectives screen 804, showing objectives and/or standing orders and considerations. Standing orders and considerations may include pre-determined or fixed orders or guidelines, which may be specific to a particular emergency or disaster, to particular geographic areas, or to particular levels of command. For example, in the interface shown, standing orders and considerations may include the mnemonic FIRE ORDERS, which stands for: Fight fire aggressively but provide for safety first; Initiate all action based on current and expected fire behavior; Recognize current weather conditions and obtain forecasts; Ensure instructions are given and understood; Obtain current information on fire status; Remain in communications with your crew, supervisor, other personnel; Determine safety zones and escape routes; Establish lookouts in potentially hazardous situations; Retain control at all times; and Stay alert, keep calm, think clearly, act decisively. Other standing orders and considerations may also be shown, such as the mnemonic LACES, which stands for: Lookout/Location; Access/Anchor; Communication; Escape routes; and Safety zone. The hierarchy 802 and the objectives screen 804 may be displayed on the incident commander screen 502, or may be shown on a separate screen or screens.

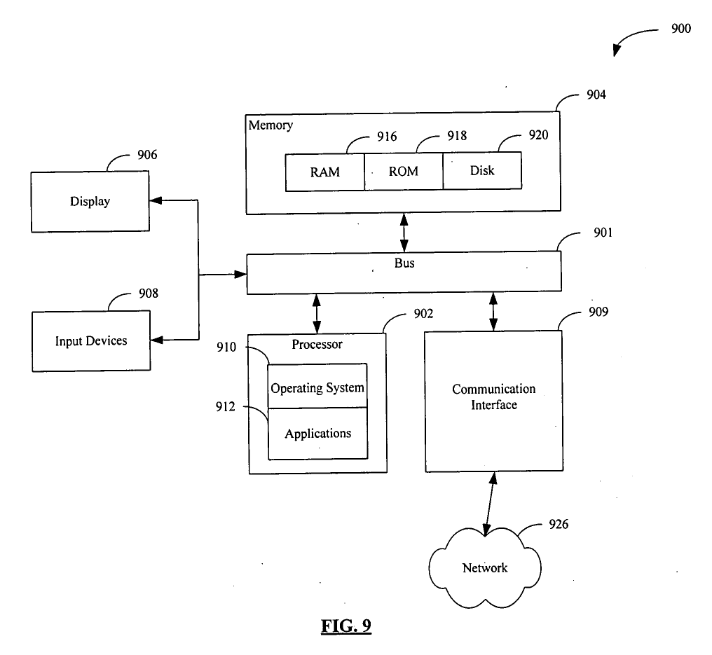

FIG. 9 illustrates a computing device architecture 900 that may be used with the system 200 and modules 202, 204, 206, 208, 210, 212, 214, and 216 described. The computing device architecture 900 may be representative of the client application, or any computing devices, servers, or computers suitable for implementing the system 200 described above. The computing device 900 generally may include a bus 901, one or more than one microprocessor or processor 902, a memory 904, a display 906, one or more user input devices 908, and a communication interface 909, which may all be coupled to the bus 901. The computing device 900 may additionally include a display device (not shown) for communicating an output to a user. In one example, the user input devices 908 may be a keyboard or pointing device such as a mouse. The communication interface 909 provides an interface for communicating with a network 926. An operating system 910 or applications 912 run on the processor 902. The memory 904 includes Random Access Memory (RAM) 916, Read Only Memory (ROM) 918, and a disk 920. In one example, the data processing system 900 may include either a client or a server. Any of the software modules 202, 204, 206, 208, 210, 212, 214, and 216 or components mentioned above may be stored in the memory 904 for execution by the processor 902.

These and other aspects and features of the present disclosure will become apparent to persons of ordinary skill in the art upon review of the above detailed description, taken in combination with the appended drawings.

While the present disclosure is primarily described as a system, a person of ordinary skill in the art will understand that the present disclosure is also directed to an apparatus including apparatus parts for performing the functions of the system, be it by way of hardware components, a computer programmed by appropriate software, by any combination of the two, or in any other manner. Moreover, an article of manufacture for use with the apparatus, such as a pre-recorded storage device or other similar computer readable medium including program instructions recorded thereon, or a computer data signal carrying computer readable program instructions, may direct an apparatus to facilitate the disclosed functions. It is understood that such apparatus, articles of manufacture, and computer data signals also come within the scope of the present disclosure.

The embodiments of the present disclosure described above are intended to be examples only, for the purposes of illustration and not intended to be limiting. Those of skill in the art may effect alterations, modifications and variations to the particular embodiments without departing from the scope of the present disclosure. In particular, selected features from one or more of the above-described embodiments may be combined to create alternative embodiments not explicitly described, features suitable for such combinations being readily apparent to persons skilled in the art. The subject matter described herein in the recited claims intends to cover and embrace all suitable changes in technology.

1. A system for workflow monitoring and regulatory compliance comprising:
a microprocessor;
an input device for accepting an input to the microprocessor;
a display device for communicating an output from the microprocessor; and
a memory coupled to the microprocessor, the memory having a plurality of program modules configured to:
receive information on safety hazards;
carry out interactions among the plurality of program modules, the interactions including communication of information on the safety hazards;
through the interactions among the plurality of program modules, identify safety procedures associated with the safety hazards; and
through the interactions among the plurality of program modules, provide a series of instructions via an output to a user for ensuring regulatory compliance based on the identified safety procedures.

2. The system of claim I wherein the plurality of program modules comprise:
a daily activities module for tracking a worker's regulatory compliance;
a training module for providing regulatory compliance training;
an inspection module for assessing the worker's regulatory compliance;
an investigations module for identifying and evaluating errors in regulatory compliance;
a maintenance and repairs module for tracking usage and maintenance of items in accordance with regulatory compliance;
an asset management module for tracking inventory of items;
a regulatory compliance module for identifying regulatory compliance requirements; and
an emergency response module for assisting in emergency response procedures in accordance with regulatory compliance requirements.

3. The system of claim 1 further comprising a common registry accessible to all users of the system, the common registry containing a list of registered vendors known to have regulatory compliance.

4. The system of claim 1 wherein the plurality of program modules are further configured to:
interact, by communication of information about at least one of assets and safety hazards, to generate a workflow based on the identified safety procedures for output to the user.

5. The system of claim 1 wherein the plurality of program modules are further configured to:
interact, by communication of information about at least one of services, resources and safety hazards, to provide emergency response assistance.

6. A method for workflow management and regulatory compliance comprising:
receiving information on safety hazards;
carrying out interactions among a plurality of program modules on a system, the interactions including communication of information on the safety hazards;
through the interactions among the plurality of program modules, identifying safety procedures associated with the safety hazards; and
through the interactions among the plurality of program modules, providing a series of instructions via an output to a user for ensuring regulatory compliance based on the identified safety procedures.

7. The method of claim 6 wherein the plurality of program modules comprise:
a daily activities module for tracking a worker's regulatory compliance;
a training module for providing regulatory compliance training;
an inspection module for assessing the worker's regulatory compliance;
an investigations module for identifying and evaluating errors in regulatory compliance;
a maintenance and repairs module for tracking usage and maintenance of items in accordance with regulatory compliance;
an asset management module for tracking inventory of items;
a regulatory compliance module for identifying regulatory compliance requirements; and
an emergency response module for assisting in emergency response procedures in accordance with regulatory compliance requirements.

8. The method of claim 6 further comprising providing a common registry accessible to all users of the system, the common registry containing a list of registered vendors known to have regulatory compliance.

9. The method of claim 6 further comprising:
through the interactions among the plurality of program modules, the interactions including communication of information about at least one of assets and safety hazards, generating a workflow based on the identified safety procedures for output to the user.

10. The method of claim 6 further comprising:
through the interactions among the plurality of program modules, the interactions including communication of information about at least one of services, resources and safety hazards, providing emergency response assistance.

11. A computer program product having a computer readable medium tangibly embodying computer executable code for workflow management and regulatory compliance, the computer program product comprising:
code for receiving information on safety hazards;
code for carrying out interactions among a plurality of program modules on a system, the interactions including communication of information on the safety hazards;
code for, through the interactions among the plurality of program modules, identifying safety procedures associated with the safety hazards; and
code for, through the interactions among the plurality of program modules, providing a series of instructions via an output to a user for ensuring regulatory compliance based on the identified safety procedures.

12. The computer program product of claim 11 wherein the plurality of program modules comprise:
a daily activities module for tracking a worker's regulatory compliance;
a training module for providing regulatory compliance training;
an inspection module for assessing the worker's regulatory compliance;
an investigations module for identifying and evaluating errors in regulatory compliance;
a maintenance and repairs module for tracking usage and maintenance of items in accordance with regulatory compliance;
an asset management module for tracking inventory of items;
a regulatory compliance module for identifying regulatory compliance requirements; and
an emergency response module for assisting in emergency response procedures in accordance with regulatory compliance requirements.

13. The computer program product of claim 11 further comprising:
code for, through the interactions among the plurality of program modules, the interactions including communication of information about at least one of assets and safety hazards, generating a workflow based on the identified safety procedures for output to the user.

14. The computer program product of claim 11 further comprising:
code for, through the interactions among the plurality of program modules, the interactions including communication of information about at least one of services, resources and safety hazards, providing emergency response assistance.
